(19) United States
(12) Patent Application Publication
(10) Pub. No.: US 2006/0184301 A1
(43) Pub. Date: Aug. 17, 2006

(54) Rollover sensing device

(75) Inventors: Nobuaki Konno, Tokyo (JP); Takashi Tokunaga, Tokyo (JP); Satoru Inoue, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/353,169

(22) Filed: Feb. 14, 2006

(30) Foreign Application Priority Data
Feb. 16, 2005 (JP) 2005-039024

(51) Int. Cl. G06F 19/00

(52) U.S. Cl. 701/45; 701/70; 340/440

(57) ABSTRACT

A rollover sensing device includes a detecting unit that includes at least a pair of acceleration sensors which detect an acceleration in an vertical direction, the pair of acceleration sensors being disposed closer to each other on a same board in a lateral direction of a vehicle, an arithmetic processing unit that calculates an angular acceleration and an angular velocity of the vehicle on a basis of an output signal from the detecting unit, and a rollover determining unit that determines whether or not a rollover of the vehicle occurs on a basis of an arithmetic result obtained by the arithmetic processing unit.

### BACKGROUND OF THE INVENTION

1. Field of the Invention

The present invention relates to a rollover sensing device for determining whether a rollover of a vehicle occurs.

2. Description of the Related Art

A related art senses rollover by detecting a roll angular velocity by using a pair of vertical acceleration sensors, and further has additional acceleration sensor to compensate an error caused by a deviation of detecting axes and mounting positions of respective vertical acceleration sensors (For example, JP-A-5-72223).

However, in the above-described rollover sensing device, since the pair of vertical acceleration sensors are separated from each other, a deviation of the detecting axes or the error of a mounting angle is occurred. Accordingly, it is necessary to correct the detecting error of the rotational angular acceleration caused by the deviation of the detecting axes or the error of the mounting angle and to provide an additional acceleration sensor, which makes a processing circuit be complicated.

The present invention provides a rollover sensing device with high reliability at low cost.

### SUMMARY OF THE INVENTION

According to an aspect of the present invention, a rollover sensing device includes a detecting unit that includes at least a pair of acceleration sensors which detect an acceleration in an vertical direction, the pair of acceleration sensors being disposed closer to each other on a same board in a lateral direction of a vehicle, an arithmetic processing unit that calculates an angular acceleration and an angular velocity of the vehicle on a basis of an output signal from the detecting unit, and a rollover determining unit that determines whether or not a rollover of the vehicle occurs on a basis of an arithmetic result obtained by the arithmetic processing unit.

According to the invention, since individual vertical acceleration sensors are disposed to closer to each other on the same board, it is possible to prevent a deviation of detecting axes and mounting positions to reduce an error. Further, since the rollover is determined by using a physical quantity with no error or slight error, it is possible to provide the rollover sensing device having a high reliability in determination.

### BRIEF DESCRIPTION OF THE DRAWINGS

FIG. 1 is a layout that sensing unit of a rollover sensing device according to a first embodiment of the present invention is mounted to a vehicle;

FIG. 2 is a functional block diagram showing the rollover sensing device according to the first embodiment of the invention;

FIGS. 3A and 3B are views illustrating a principle of detection of an angular velocity from a pair of acceleration sensors, in which FIG. 3A is a view illustrating a principle detecting an angular velocity from force caused by a rotation, and FIG. 3B is a view illustrating a principle detecting an angular velocity from a force of same direction;

FIG. 4 is a view showing a two dimensional map of a rollover determination by using a roll angle θ and an angular velocity ω;

FIG. 5 is a view showing a two dimensional map of a rollover determination by using an vertical acceleration Gz and the angular velocity ω;

FIG. 6 is a functional block diagram showing a construction of the rollover sensing device according to a second embodiment of the invention;

FIG. 7 is a functional block diagram showing a construction of the rollover sensing device according to a third embodiment of the invention; and

FIG. 8 is a functional block diagram showing a construction of the rollover sensing device according to a fourth embodiment of the invention.

### DETAILED DESCRIPTION OF THE INVENTION

### First Embodiment

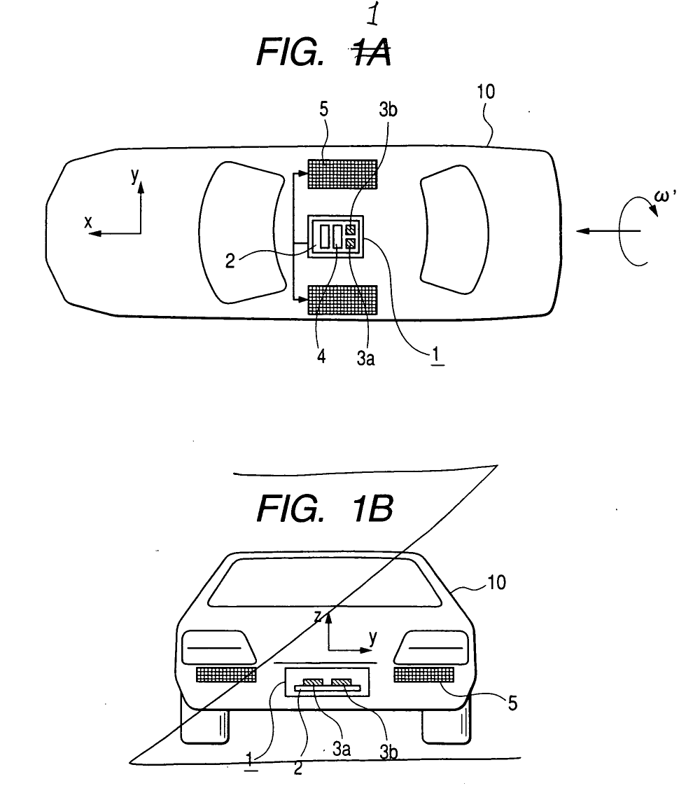

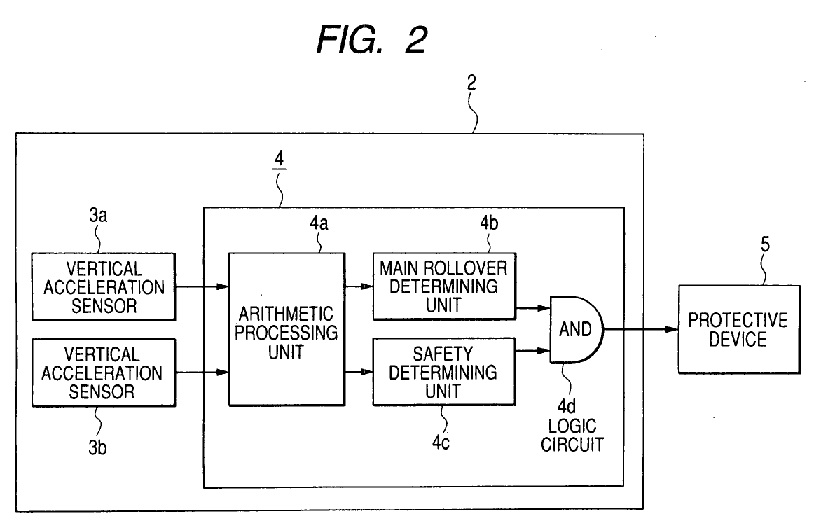

FIG. 1 is a view showing layout that a sensing unit of a rollover sensing device according to the first embodiment of the present invention is mounted on a vehicle, and FIG. 2 is a functional block diagram showing the rollover sensing device.

In the drawings, for example, a unit 1 of the rollover sensing device is mounted between a driver seat and passenger seat of the vehicle 10. The unit 1 includes an acceleration sensor 3 serving as a detecting unit and an arithmetic processing unit. Specifically, at least one pair of vertical acceleration sensors 3a and 3b are connected to a determination device 4, and disposed on the same board 2 so as to be closer to each other with a gap in a lateral direction (Y direction), thereby detecting an acceleration acting in the vertical direction (Z direction) of the vehicle 10, as the vertical acceleration.

The determination device 4 includes an arithmetic processing unit 4a, two rollover determining units 4b and 4c, and a logic circuit 4d. The arithmetic processing unit 4a performs a filtering process on an vertical acceleration signal from the vertical acceleration sensors 3a and 3b, a calculation of the physical quantities such as an angular acceleration, an angular velocity and a roll angle on the basis of a difference between outputs of the vertical acceleration sensors, and an arithmetic process such as an integration and an addition on the respective physical quantities. The rollover determining unit may include a main rollover determining unit 4b and a safety determining unit 4c, if necessary. The main rollover determining unit 4b selects a determination item from the arithmetic result by the arithmetic processing unit 4a, estimates the determination value by using the rollover determination threshold value map to make a determination of the rollover. In addition, the safety determining unit 4c determines a rollover possibility by referring the vertical acceleration signals of the vertical acceleration sensors 3a and 3b. If the rollover determining unit includes the safety determining unit 4c, the outputs of the two determination units 4b and 4c are input into the logic circuit 4d, and then the rollover is determined. Meanwhile, if the rollover determining unit does not include the safety determining unit 4c, the output from the main rollover determining unit 4b serves as a determination output. It is general that a circuit configuring the arithmetic processing unit or determination unit is disposed on a printed wiring board 2, together with the acceleration sensors 3a and 3b, as a processing unit. Since the sensors and processing circuit are provided on the same board, the wiring is simplified, and when a unit is accommodated in a case, mounting into the vehicle is made easier. Further, since the sensors and processing circuit are disposed in the same board and in the same case, surrounding environments thereof are similar to each other. Accordingly, variations of the respective sensors are substantially equal.

Since the output of the rollover determination from the main rollover determining unit 4b is supplied to a control unit of a protective device 5 including a side air bag device which is provided on the exterior, as a starting output, when the vehicle is rolled over, the protective device 5 deploys the side air bag or a curtain air bag, etc, to protect an occupant.

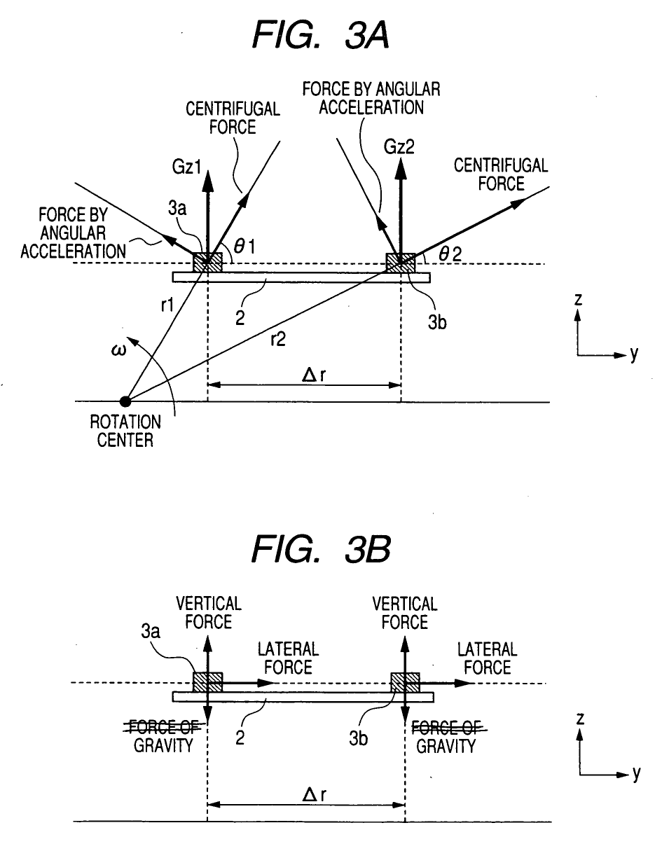

Next, a principle which detects the roll angle, the angular velocity and the angular acceleration is shown in FIGS. 3A and 3B. When the roll happens in the vehicle, FIG. 3A a force by the rotation (a centrifugal force, a force by the angular acceleration) and FIG. 3B a force of same direction such as impact (a lateral acceleration, a vertical acceleration, gravity) are produced in the two vertical acceleration sensors 3a and 3b. In this case, the force Fz1 produced in the first vertical acceleration sensor 3a and the force Fz2 produced in the second vertical acceleration sensor 3b are expressed as following equations.
Fz1=m·r1·ω²sinθ1+m·r1·ω′cosθ1+Gz=m·Gz1 (1)
Fz2=m·r2·ω²sinθ2+m·r2·ω′cosθ2+Gz=m·Gz2 (2)

Where, m indicates a mass of the sensor element, r1 indicates a distance from the rotational center of the first vertical acceleration sensor 3a, r2 indicates a distance from the rotational center to the second vertical acceleration sensor 3b, θ1 indicates an angle between a line connecting two acceleration sensors and a direction of the centrifugal force produced in the first acceleration sensor 3a, θ2 indicates an angle between a line connecting two acceleration sensors and a direction of the centrifugal force produced in the second acceleration sensor 3b, ω indicates a rotational angular velocity, ω′ indicates a rotational angular acceleration, Gz indicates an acceleration by a vertical force plus the gravity, Gz1 indicates an acceleration produced in the first vertical acceleration sensor, and Gz2 indicates an acceleration produced in the second vertical acceleration sensor.

If the equation (2) is subtracted from (1), the following equation is given.
Fz1−Fz2=m·ω²(r1 sinθ1−r2 sinθ2)+m·ω′(r1cosθ1−r2 cosθ2)=m(Gz1 −Gz2) (3)

Where, if Δr is the distance between the two acceleration sensors, the equation (3) is expressed as the equation (4) by using the following equations;
r1 cosθ1−r2 cosθ2=Δr
r1 sinθ1=r2 sinθ2
ω′=(Gz1×Gz2)/Δr (4)

By integrating the equation (4), the angular velocity ω may be calculated, and by integrating even further, the roll angle θ may be calculated.

In a method of the related art, since the vertical acceleration sensors 3a and 3b are not formed on the same board, an attaching error occurs. Accordingly, the Gz in the equation (1) is not equal to the Gz in the equation (2), and the Gz1 and Gz2 are not calculated as the equations. As a result, it needs to perform correction and a process in which the error can be ignored. However, in the present invention, since the vertical acceleration sensors 3a and 3b are formed on the same board, the error is generated only due to a thickness of a solder. Accordingly, detecting axes of the two sensors are almost equal, and the Gz in the equations (1) and (2) are almost equal. As a result, it maybe calculated as the above-mentioned equations. Further, the sensor does not need to be horizontally disposed on a road, as in case when the acceleration sensors are separately attached, and even though the board is disposed at an angle, it is possible to detect the roll angular velocity without difficulty.

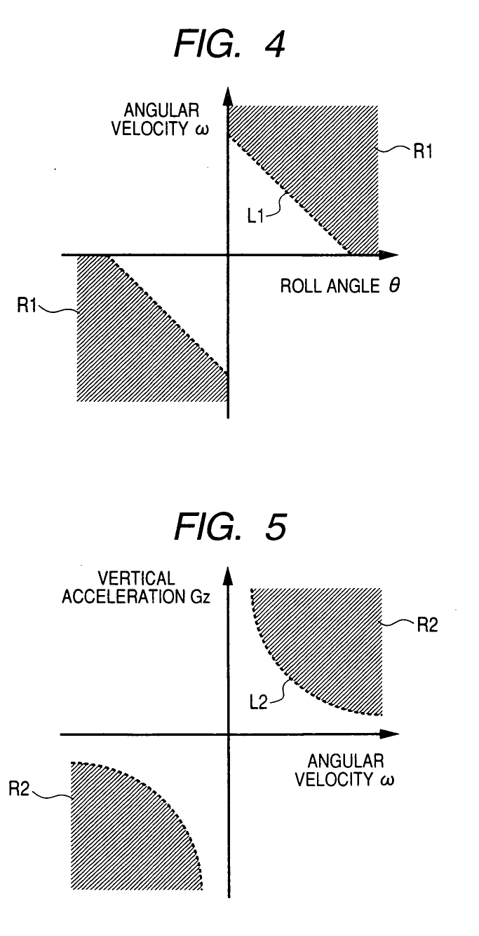

Next, the determination of the rollover will be described. There are several methods that the physical quantities (roll angle, angular velocity, vertical acceleration and angular acceleration, etc.), which are measured or calculated, are combined so as to judge the rollover. FIG. 4 is a graph showing a determination region R1 to judge the rollover by using the roll angle θ and the angular velocity ω.

When it is determined that the roll angle θ which is an inclinational angle and the angular velocity ω extend the rollover determination threshold value line L1 to reach the determination region R1, the determination output of the rollover generation acts as a starting output. In addition, it is possible to detect the generation of the rollover that does not accompany a large acceleration and the angular velocity such as corkscrew which rotates around the vicinity of the vehicle center due to the configuration of the road and the velocity of the vehicle.

Meanwhile, in the rollover such as a curbtrip caused by the vehicle crash, the rotation happens due to the crash in the lateral direction of the vehicle, which accompanies rapid and high acceleration. In this case, since the determination is not performed in a suitable timing of the air bag, in the rollover generating threshold value map of the roll angle θ and an angular velocity ω shown in FIG. 4, the determination corresponding to a value of the angular acceleration or acceleration is required.

FIG. 5 is a graph showing a determination region R2 by using the vertical acceleration Gz and the angular velocity ω which determines the rollover.

In the curbtrip type, when it is determined that the vertical acceleration Gz and the angular velocity ω extend the rollover determination threshold line L2 to reach the determination region R2, or the angular acceleration ω′ extends the threshold value, the determination output of the rollover generation acts as a starting output. The safety determining unit 4c for determining a rollover possibility has a function which does not output the deployment signal (an error signal which allows the protective device to deploy) by the vertical acceleration signal detected downwardly, when the vehicle runs a bank curve having the inclinational angle as if it reaches the determination region R1.

Generally, in the rollover determining unit, in order to prevent an error operation (despite the rollover is not occurred, it is determined as ON), another determination route (safety determination) differing from the main determination is provided. According to the first embodiment of the invention, as the safety determining unit, the main determination and a method that changes an algorithm to prevent the error operation are described. It is general that the safety determination has a lower threshold value than the main determination.

In the method that determines whether or not the rollover occurs by using the threshold value line with respect to two dimensional map between the roll angle θ and the roll angular velocity ω, at least one physical quantity such as two dimensional map between the vertical acceleration Gz and the roll angular velocity ω, and the angular acceleration ω′, the rollover sensing device with a high reliability is realized by adding the value of the vertical acceleration Gz, the roll angle θ, the angular velocity o and the angular acceleration ω′ obtained on the basis of the vertical acceleration sensor signal, as the determination equation or the safety function.

As described above, according to the first embodiment of the invention, since the vertical acceleration sensors are disposed on the same board, it is possible to prevent a deviation of detecting axes and mounting position to reduce an error. Further, since the rollover is determined by using the physical quantity with no error or slight error, it is possible to provide the rollover sensing device with a high reliability in determination. Furthermore, since the detecting unit and processing circuit are provided on the same board, it does not need to provide external wiring. In addition, since the units are disposed on the same board and the case, surrounding environments thereof are similar to each other. Accordingly, variations of the respective sensors are substantially equal.

### Second Embodiment

FIG. 6 is a functional block diagram showing the rollover sensing device according to the second embodiment of the invention.

In the FIG. 6, at least a pair of vertical acceleration sensors 3a and 3b, and an angular velocity sensor 6 are connected to a determination device 4 as detecting unit. The at least a pair of vertical acceleration sensors 3a and 3b are disposed on the same board to be separated from each other in a lateral direction, thereby detecting the acceleration acting on the vertical direction of the vehicle as the vertical acceleration, and an angular velocity sensor 6 detects the rotational angular velocity acting around an axis in a front and rear direction of the vehicle as the angular velocity.

The determination device 4 includes an arithmetic processing unit 4a, a main rollover determining unit 4b, and a safety determining unit 4c. The arithmetic processing unit 4a performs a filtering process on vertical acceleration signals from the vertical acceleration sensors 3a and 3b and the angular velocity signal from the angular velocity sensor 6, a calculation of an angular acceleration, an angular velocity and a roll angle on the basis of a difference between outputs of the vertical acceleration sensors, a calculation of the physical quantities by an integration and a differentiation of the angular velocity sensor output, and an arithmetic process such as an integration and an addition on the respective physical quantities. The main rollover determining unit 4b selects a determination item from the arithmetic results by the arithmetic processing unit 4a, estimates the determination value by using the rollover determination threshold value map, and determines the rollover generation. The safety determining unit 4c determines a rollover possibility by referring the angular velocity, the roll angle and the acceleration calculated by a sensor other than the sensor used for the main rollover determining unit 4b.

The determination output of the rollover generation from the main rollover determining unit 4b is supplied to a protective device 5 including a side air bag device provided on the exterior, as a starting output. Therefore, when the vehicle is rolled over, the protective device 5 deploys the side air bag or a curtain air bag, etc, to protect an occupant.

Generally, the sensor used for the safety determining unit 4c which determines the rollover possibility differs from the sensor used for the main determination. Accordingly, when using the determination unit by the angular velocity sensor and the determination unit by the pair of acceleration sensors, one is used for the main determination, and the other is used for the safety determination. Further, in the arithmetic processing unit 4a, by using two sensors are used for the main determination and the safety determination, the determination becomes completely independent and has the higher reliability.

### Third Embodiment

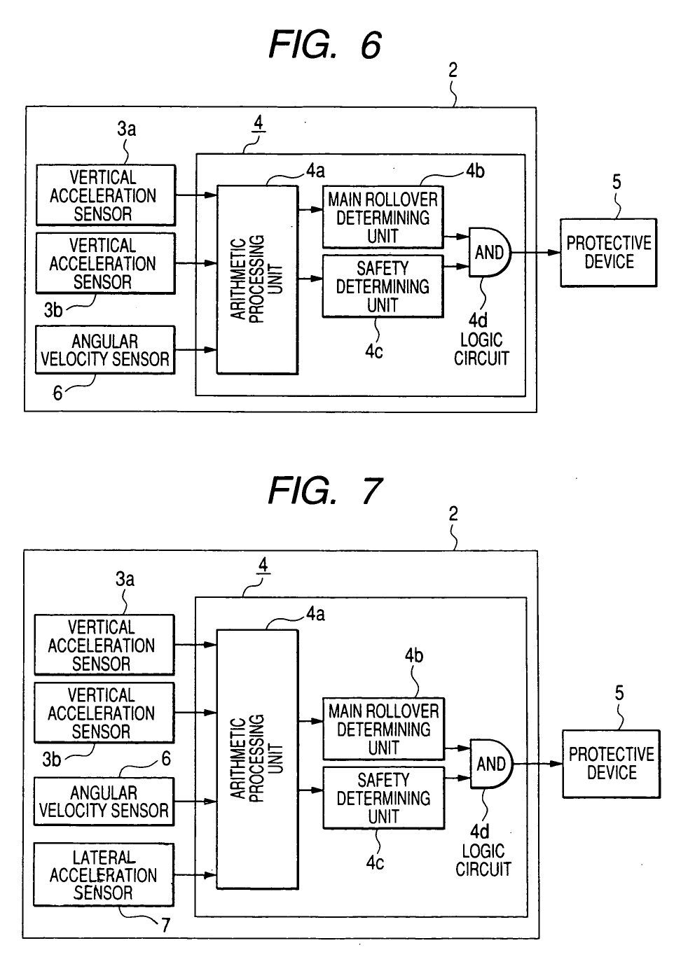

FIG. 7 is a functional block diagram showing the rollover sensing device according to the third embodiment of the invention.

In the FIG. 7, at least a pair of vertical acceleration sensors 3a and 3b, an angular velocity sensor 6, and a lateral acceleration sensor 7 are connected to a determination device 4 as a detecting unit. The at least a pair of vertical acceleration sensors 3a and 3b are disposed on the same board to be separated from each other in a lateral direction, thereby detecting the acceleration acting on the vertical direction of the vehicle as the vertical acceleration, and an angular velocity sensor 6 detects the rotational angular velocity acting on an axis circumference of a front-rear direction of the vehicle as the angular velocity. The lateral acceleration sensor 7 detects the acceleration acting on the vehicle, as the acceleration of the lateral direction.

The determination device 4 includes an arithmetic processing unit 4a, a main rollover determining unit 4b, and a safety determining unit 4c. The arithmetic processing unit 4a performs a filtering process on vertical acceleration signals from the vertical acceleration sensors 3a and 3b, an acceleration signal from the lateral acceleration sensor 7 and the angular velocity signal from the angular velocity sensor 6, a calculation of the angular acceleration, the angular velocity and a roll angle on the basis of a difference between outputs of the vertical acceleration sensors, a calculation of the physical quantities by an integral and a differential arithmetic of output from the angular velocity sensor and lateral acceleration sensor, and an arithmetic processing such as an integral processing and an add processing corresponding to the respective physical quantities. The main rollover determining unit 4b selects a determination item from the arithmetic results by the arithmetic processing unit 4a, estimates the determination value by using the rollover determination threshold value map, and determines the rollover generation. The safety determining unit 4c determines a rollover possibility by referring the angular velocity, the roll angle and the acceleration calculated by a sensor other than the sensor used for the main rollover determining unit 4b.

The determination output of the rollover generation from the main rollover determining unit 4b is supplied to a protective device 5 including a side air bag device provided on the exterior, as a starting output. Therefore, when the vehicle is rolled over, the protective device 5 deploys the side air bag or a curtain air bag, etc, to protect an occupant.

As comparing to the second embodiment of the invention, by adding the lateral acceleration sensor 7, the determination by a Gy−ω map or the threshold value of a ω−θ is changeable. In addition, since it is possible to detect an inclination of the vehicle and a motion of the head of the passenger, the rollover sensing device with the higher reliability may be possible.

Further, the rollover sensing device may be composed of the vertical acceleration sensors 3a and 3d, and the lateral acceleration sensor 7 by removing the angular velocity sensor 6, and the lateral acceleration sensor 7 has a sensing function, thus providing inexpensive rollover sensing device.

### Fourth Embodiment

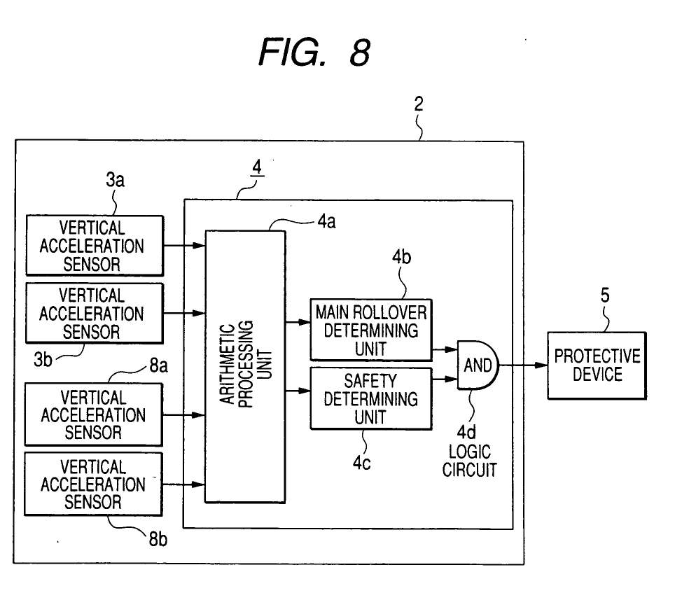

FIG. 8 is a functional block diagram showing the rollover sensing device according to the fourth embodiment of the invention.

In the FIG. 8, two pairs of vertical acceleration sensors 3a and 3b, and 8a and 8b are connected to a determination device 4 as a detecting unit. The two pairs of vertical acceleration sensors 3a and 3b, and 8a and 8b are disposed on the same board to be separated from each other in a lateral direction, thereby detecting the acceleration acting on the vertical direction of the vehicle as the vertical acceleration.

The determination device 4 includes an arithmetic processing unit 4a, a main rollover determining unit 4b, and a safety determining unit 4c. The arithmetic processing unit 4a performs a filtering process on vertical acceleration signals from the vertical acceleration sensors 3a and 3b, and 8a and 8b, and the angular velocity signal from the angular velocity sensor 6, a calculation of the angular acceleration, the angular velocity and a roll angle on the basis of a difference between outputs of the vertical acceleration sensors, and an arithmetic processing such as an integral processing and an add processing corresponding to the respective physical quantities. The main rollover determining unit 4b selects a determination item from the arithmetic results by the arithmetic processing unit 4a, evaluates the determination value by using the rollover determination threshold value map, and determines the rollover generation. The safety determining unit 4c determines a rollover possibility by referring the angular velocity, the roll angle and the acceleration calculated by a sensor other than the sensor used for the main rollover determining unit 4b.

The determination output of the rollover generation from the main rollover determining unit 4b is supplied to a protective device 5 including a side air bag device provided on the exterior, as a starting output. Therefore, when the vehicle is rolled over, the protective device 5 deploys the side air bag or a curtain air bag, etc, to protect an occupant.

Since the rollover sensing device is configured by only vertical acceleration sensors, the main determining unit and the safety determining unit, the manufacturing cost can be reduced.

The second to fourth embodiments of the invention differ from the first embodiment, and relate to the method which prevents the error operation by using a sensor different from the determination unit. In this case, the main determination unit and the algorithms may be equal or not.

What is claimed is:

1. A rollover sensing device comprising:
a detecting unit that includes at least a pair of acceleration sensors which detect an acceleration in an vertical direction, the pair of acceleration sensors being disposed closer to each other on a same board in a lateral direction of a vehicle;
an arithmetic processing unit that calculates an angular acceleration and an angular velocity of the vehicle on a basis of an output signal from the detecting unit; and
a rollover determining unit that determines whether or not a rollover of the vehicle occurs on a basis of an arithmetic result obtained by the arithmetic processing unit.

2. The rollover sensing device according to claim 1, wherein
the detecting unit further includes an angular velocity sensor that detects an angular velocity of the vehicle.

3. The rollover sensing device according to claim 1, wherein
the detecting unit further includes an acceleration sensor that detects an acceleration in the lateral direction of the vehicle.

4. The rollover sensing device according to claim 1, wherein
the detecting unit further includes another pair of acceleration sensors which detect an vertical acceleration, the another pair of acceleration sensors being disposed closer to each other on the same board in the lateral direction of the vehicle.

5. The rollover sensing device according to claim 1, wherein
the rollover determining unit includes two determination units, and
the rollover determining unit determines whether or not the rollover of the vehicle occurs by a logical add operation of outputs from the two determination units.

6. The rollover sensing device according to claim 1, further comprising:
a protective device, wherein
the protective device activates on a basis of an output from the rollover determining unit.

7. The rollover sensing device according to claim 1, wherein
the detecting unit, the arithmetic processing unit and the rollover determining unit are formed on the same board to form a sensing unit.

8. The rollover sensing device according to claim 1, wherein
the rollover determining unit includes two determination units,
the rollover determining unit determines whether or not the rollover of the vehicle occurs by a logical add operation of outputs from the two determination units, and
the detecting unit further includes an angular velocity sensor that detects an angular velocity of the vehicle.

9. The rollover sensing device according to claim 1, wherein
the rollover determining unit includes two determination units,
the rollover determining unit determines whether or not the rollover of the vehicle occurs by a logical add operation of outputs from the two determination units, and
the detecting unit further includes an acceleration sensor that detects an acceleration in the lateral direction of the vehicle.

10. The rollover sensing device according to claim 1, wherein
the rollover determining unit includes two determination units,
the rollover determining unit determines whether or not the rollover of the vehicle occurs by a logical add operation of outputs from the two determination units, and
the detecting unit further includes another pair of acceleration sensors which detect an vertical acceleration, the another pair of acceleration sensors being disposed closer to each other on the same board in the lateral direction of the vehicle.
